(19) United States
(12) Patent Application Publication
(10) Pub. No.: US 2026/0209489 A1
(43) Pub. Date: Jul. 23, 2026

(54) RUBBER COMPOSITION COMPRISING A HIGHLY SATURATED DIENE ELASTOMER

(71) Applicant: COMPAGNIE GENERALE DES ETABLISSEMENTS MICHELIN, Clermont-Ferrand (FR)

(72) Inventors: THOMAS FERRAND, Clermont-Ferrand (FR); FABIEN ROUDAUT, Clermont-Ferrand (FR); GUILLAUME PIBRE, Clermont-Ferrand (FR)

(21) Appl. No.: 19/138,427

(22) PCT Filed: Dec. 12, 2023
(86) PCT No.: PCT/EP2023/085404

§ 371 Date: Jun. 12, 2025

(30) Foreign Application Priority Data
Dec. 15, 2022 (FR) FR2213468

(51) Int. Cl. C08L 23/0807; B60C 1/00; B60C 11/00

(52) U.S. Cl. CPC C08L 23/083; B60C 1/0016; B60C 11/0008; B60C 2011/0025; C08L 2207/324; C08L 2312/00

(57) ABSTRACT

The present invention relates to a rubber composition based on at least an elastomer matrix predominantly comprising a highly saturated diene elastomer, a reinforcing filler, a vulcanization system, and a liquid butadiene polymer functionalized along the chain by pendent alkoxysilyl functions, having a number-average molar mass (Mn) greater than or equal to 1000 g/mol.

The highly saturated diene elastomer is a copolymer of ethylene and of a 1,3-diene in which the ethylene units represent at least 50 mol % of the monomer units of the copolymer.

### TECHNICAL FIELD

The field of the present invention is that of rubber compositions based on a highly saturated diene elastomer, which are intended to be used in a tyre, notably in its tread.

### PRIOR ART

The use of a highly saturated diene elastomer is known in the manufacture of tyres. For example, the applicant has described copolymers of ethylene and 1,3-butadiene and the use thereof in a tyre tread in document WO 2014/114607 A1. This document indicates that the use of these copolymers in treads results in good wear resistance and rolling resistance properties of the tyre.

Tyre manufacturers are always looking for solutions to improve tyre performance. This research involves the constant improvement of the properties of the rubber compositions which are used in the manufacture of tyres. However, the compositions that make up the tyre generally satisfy a compromise of properties. Thus it is an ongoing objective of the designers of the compositions to ensure that the improvement of certain properties does not come at the expense of others. In the abovementioned field of tyres comprising a highly saturated diene elastomer in the tread, there is a need, particularly under certain conditions of transporting heavy loads, to have rubber compositions which give the tyre increased stiffness in order to improve road handling, and also improved hysteresis properties in order to minimize rolling resistance.

### DISCLOSURE OF THE INVENTION

Continuing its efforts, the applicant has found a rubber composition which makes it possible to meet this need in the field of application of highly saturated diene elastomers in rubber compositions for tyres and in particular for the tread. Very particularly, the applicant has found, against all expectations, a rubber composition which combines the use of a highly saturated diene elastomer with the use of a liquid butadiene polymer functionalized along the chain by alkoxysilyl functions, and which makes it possible to significantly reduce the hysteresis while increasing the stiffness of the composition compared to compositions using non-functional liquid polybutadienes. These properties promise to give the tyre good rolling resistance properties and improved road handling, especially when transporting heavy loads.

Thus, a first subject of the invention is a rubber composition based on at least:
an elastomeric matrix predominantly comprising a highly saturated diene elastomer,
a reinforcing filler,
a vulcanization system, and
a liquid butadiene polymer functionalized along the chain by alkoxysilyl functions, which are optionally partially or completely hydrolysed.

Another subject of the invention is a pneumatic or non-pneumatic tyre which comprises a rubber composition in accordance with the invention, preferably in its tread.

### SUMMARY OF THE INVENTION

The invention, which is described in greater detail below, has as subject at least one of the embodiments listed in the following points:
1. Rubber composition based on at least
   an elastomer matrix predominantly comprising a highly saturated diene elastomer, which highly saturated diene elastomer is a copolymer of ethylene and a 1,3-diene in which the ethylene units represent at least 50 mol % of the monomer units of the copolymer,
   a reinforcing filler,
   a vulcanization system, and
   a liquid butadiene polymer functionalized along the chain by pendent alkoxysilyl functions, which are optionally partially or completely hydrolysed, having a number-average molar mass (Mn) greater than or equal to 1000 g/mol.
2. Rubber composition according to embodiment 1, in which the ethylene units represent from 50 mol % to 95 mol % of the monomer units of the highly saturated diene copolymer.
3. Rubber composition according to either one of the preceding embodiments, in which the ethylene units represent at least 60 mol % of the monomer units of the highly saturated diene copolymer, preferably from 65 mol % to 90 mol % of the monomer units of the highly saturated diene copolymer.
4. Rubber composition according to any one of the preceding embodiments, in which the 1,3-diene is 1,3-butadiene, isoprene, myrcene or β-farnesene or a mixture of myrcene and 0-farnesene, preferably 1,3-butadiene.
5. Rubber composition according to any one of the preceding embodiments, in which the copolymer of ethylene and a 1,3-diene is a copolymer of ethylene and 1,3-butadiene.
6. Rubber composition according to any one of the preceding embodiments, in which the copolymer is a random copolymer.
7. Rubber composition according to any one of the preceding embodiments, in which the content of highly saturated diene elastomer varies within a range extending from 60 to 100 phr, preferably from 80 to 100 phr and very preferentially from 90 to 100 phr.
8. Composition according to any one of the preceding embodiments, in which the liquid butadiene polymer is a liquid polybutadiene functionalized along the chain by pendent alkoxysilyl functions, which are optionally partially or completely hydrolysed.
9. Composition according to any one of the preceding embodiments, in which the alkoxysilyl functions have the formula Si(OR)ₙR′₃₋ₙ, in which each R, independently of the others, denotes a hydrogen atom or a C₁-C₁₀ alkyl, preferably a C₁-C₄ alkyl, each R′, independently of the others, denotes a C₁-C₁₀ alkyl, preferably a C₁-C₄ alkyl, and n is an integer from 1 to 3, preferably 3.
10. Composition according to any one of the preceding embodiments, in which the alkoxysilyl functions are functions corresponding to the formula Si(OR)₃, in which each R, independently of the others, denotes a hydrogen atom or a C₁-C₁₀ alkyl, preferably a C₁-C₄ alkyl, preferably a C₁-C₄ alkyl.
11. Composition according to any one of the preceding embodiments, in which the alkoxysilyl functions are trimethoxysilyl or triethoxysilyl functions, which are optionally partially or completely hydrolysed.
12. Composition according to any one of the preceding embodiments, in which the content of liquid butadiene polymer functionalized along the chain by pendent alkoxysilyl functions, which are optionally completely or partially hydrolysed, is within a range of from 1 to 30 phr, preferably from 5 to 15 phr.
13. Composition according to any one of the preceding embodiments, in which the liquid butadiene polymer functionalized along the chain by pendent alkoxysilyl functions has a Tg within a range extending from −60° C. to −100° C., more preferentially from −80° C. to −100° C., measured by DSC according to the standard ASTM D3418 (1999).
14. Composition according to any one of the preceding embodiments, in which the liquid butadiene polymer functionalized along the chain by pendent alkoxysilyl functions has a number-average molar mass of greater than or equal to 1000 g/mol and less than or equal to 50 000 g/mol, preferably less than or equal to 30 000 g/mol, even more preferentially less than or equal to 10 000 g/mol, measured by SEC.
15. Composition according to any one of the preceding embodiments, in which the liquid butadiene polymer functionalized along the chain by pendent alkoxysilyl functions has a number-average molar mass ranging from 1000 g/mol to 10 000 g/mol.
16. Composition according to any one of the preceding embodiments, in which the liquid butadiene polymer comprises units:

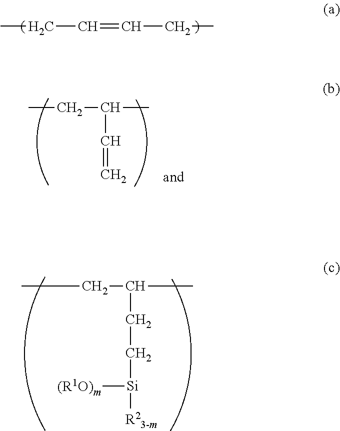

each R¹ representing, independently, a hydrogen atom or a C₁-C₁₀ alkyl radical or C₆-C₁₀ aryl radical, preferably a C₁-C₄ alkyl;
each R² representing, independently, a C₁-C₁₀ alkyl radical or C₆-C₁₀ aryl radical, preferably a C₁-C₄,
m is an integer and is equal to 1, 2 or 3, preferably 3.
17. Composition according to the preceding embodiment, in which the liquid butadiene polymer comprises a content of units (b) of at most 10 mol % relative to the polybutadiene, preferably from 0 to 5 mol %.
18. Composition according to either one of embodiments 16 and 17, in which the liquid butadiene polymer does not comprise a 1,2-vinyl unit (b).
19. Composition according to any one of embodiments 16 to 18, in which the liquid butadiene polymer exclusively consists of units (a) and units (c).
20. Composition according to any one of the preceding embodiments, in which the reinforcing filler comprises at least a silica, a carbon black or a mixture of silica and carbon black.
21. Composition according to any one of the preceding embodiments, in which the reinforcing filler comprises a silica as the predominant reinforcing filler.
22. Composition according to any one of the preceding embodiments, in which the content of reinforcing filler is within a range extending from 5 to 150 phr.
23. Composition according to any one of the preceding embodiments, in which the content of silica is within a range extending from 20 to 60 phr.
24. Pneumatic or non-pneumatic tyre comprising a composition according to any one of the preceding embodiments.
25. Pneumatic or non-pneumatic tyre according to the preceding embodiment comprising a composition according to any one of embodiments 1 to 23 in all or part of its tread.

### Definitions

The expression “composition based on” should be understood to mean a composition including the mixture and/or the product of the in situ reaction of the various constituents used, some of these constituents being able to react and/or being intended to react with one another, at least partially, during the various phases of manufacture of the composition; it thus being possible for the composition to be in the completely or partially crosslinked state or in the non-crosslinked state.

For the purposes of the present invention, the expression “part by weight per hundred parts by weight of elastomer” (or phr) should be understood as meaning the part by mass per hundred parts by mass of elastomer.

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b). In the present document, when an interval of values is denoted by the expression “from a to b”, the interval represented by the expression “between a and b” is also denoted.

In the present application, the expression “all of the monomer units of the elastomer” or “the total amount of the monomer units of the elastomer” means all the constituent repeating units of the elastomer which result from the insertion of the monomers into the elastomer chain by polymerization. Unless otherwise indicated, the contents of a monomer unit or repeating unit in the highly saturated diene elastomer are given as molar percentages calculated on the basis of all of the monomer units of the elastomer.

In the present invention, the contents of a monomer unit or repeating unit in a liquid butadiene polymer are given as molar percentages calculated on the basis of the polybutadiene part of the liquid polymer.

When reference is made to a “predominant” compound, this is understood to mean, for the purposes of the present invention, that this compound is predominant among the compounds of the same type in the composition, that is to say that it is the one which represents the greatest amount by weight among the compounds of the same type. Thus, for example, a predominant elastomer is the elastomer representing the greatest weight relative to the total weight of the elastomers in the composition. In the same way, a “predominant” filler is the one representing the greatest weight among the fillers of the composition. By way of example, in a system comprising only one elastomer, the latter is predominant for the purposes of the present invention, and in a system comprising two elastomers, the predominant elastomer represents more than half of the weight of the elastomers. In contrast, a “minor” compound is a compound which does not represent the greatest fraction by weight among the compounds of the same type. Preferably, “predominant” is understood to mean a weight proportion of more than 50%; when the compound represents 100% by weight, it is also referred to as “predominant”.

The compounds mentioned in the description may be of fossil origin or may be biobased. In the latter case, they may be partially or completely derived from biomass or obtained from renewable raw materials derived from biomass. In the same way, the compounds mentioned can also originate from the recycling of pre-used materials, that is to say that they can, partially or completely, result from a recycling process, or else be obtained, partially or completely, from starting materials which themselves result from a recycling process. They are in particular polymers, fillers, etc.

Unless otherwise indicated, as is the case in the examples presented below, the glass transition temperature (Tg) values described herein are measured in a known manner by DSC (differential scanning calorimetry) according to the standard ASTM D3418 (1999).

### DETAILED DESCRIPTION OF THE INVENTION

### 1—Elastomer Matrix

The term “elastomer matrix” means all the elastomers of the composition.

According to the invention, the elastomer matrix predominantly comprises at least one highly saturated diene elastomer, namely a copolymer containing ethylene units and 1,3-diene units (referred to hereinbelow as “the copolymer”).

The highly saturated diene elastomer that is useful for the purposes of the invention is a copolymer, preferably a random copolymer. In a known way, the term “random copolymer” is understood to mean a copolymer in which the sequential distribution of the monomer units obeys a known statistical law.

The highly saturated diene elastomer that is useful for the purposes of the invention is a copolymer which comprises ethylene units resulting from the polymerization of ethylene. In a known manner, the term “ethylene unit” refers to the —(CH₂—CH₂)— unit resulting from the insertion of ethylene into the elastomer chain. The highly saturated diene elastomer is rich in ethylene units, since the ethylene units represent at least 50 mol % of all of the monomer units of the elastomer. The maximum proportion of the ethylene units is set by the elastomeric nature of the polymer; this proportion is preferably at most 95 mol %, more preferentially at most 90 mol %, more preferentially still at most 85 mol %. Thus, preferentially, the highly saturated diene elastomer comprises from 50 mol % to 95 mol % of ethylene units, the molar percentage being calculated on the basis of all of the monomer units of the highly saturated diene elastomer.

Preferably, the highly saturated diene elastomer comprises at least 60 mol % of ethylene units. In other words, the ethylene units preferentially represent at least 60 mol % of all of the monomer units of the highly saturated diene elastomer. More preferentially, the ethylene units represent at least 65 mol % of all of the monomer units of the highly saturated diene elastomer, more preferentially at least 70 mol % of all of the monomer units of the highly saturated diene elastomer. More preferentially, the highly saturated diene elastomer comprises from 65 mol % to 90 mol % of ethylene units, the molar percentage being calculated on the basis of all of the monomer units of the highly saturated diene elastomer.

Since the highly saturated diene elastomer according to the invention is a copolymer of ethylene and of a 1,3-diene, it also comprises 1,3-diene units resulting from the polymerization of a 1,3-diene. In a known manner, the expression “1,3-diene unit” refers to the units resulting from the insertion of the 1,3-diene.

The 1,3-diene units are those, for example, of a 1,3-diene containing 4 to 24 carbon atoms.

The following are suitable in particular as 1,3-diene: butadiene, isoprene, 2,3-di(C₁-C₅ alkyl)-1,3-butadienes, such as for example 2,3-dimethyl-1,3-butadiene, 2,3-diethyl-1,3-butadiene, 2-methyl-3-ethyl-1,3-butadiene or 2-methyl-3-isopropyl-1,3-butadiene, aryl-1,3-butadienes such as phenyl-1,3-butadiene, or 1,3-pentadiene. The following are also suitable as 1,3-diene: a 1,3-diene of formula CH₂═CR—CH═CH₂, in which R represents a hydrocarbon chain containing 3 to 20 carbon atoms, such as for example a linear monoterpene (C₁₀H₁₆), for instance myrcene, a linear sesquiterpene (C₁₅H₂₄), for instance β-farnesene, etc.

The highly saturated diene elastomer is preferably a copolymer of ethylene and a 1,3-diene from among 1,3-butadiene, isoprene, myrcene and β-farnesene, and a mixture of myrcene and β-farnesene.

Preferably, the 1,3-diene is 1,3-butadiene or isoprene, more preferentially 1,3-butadiene, in which case the highly saturated diene elastomer is a copolymer of ethylene and 1,3-butadiene, preferably a random copolymer.

According to the invention, in particular when the first 1,3-diene is 1,3-butadiene or a mixture of 1,3-butadiene and of at least one other 1,3-diene, the highly saturated diene elastomer may also contain 1,2-cyclohexanediyl units. The presence of these cyclic structures in the copolymer results from a very particular insertion of ethylene and 1,3-butadiene during the polymerization. The content of 1,2-cyclohexanediyl units in the copolymer varies according to the respective contents of ethylene and of 1,3-butadiene in the copolymer. The copolymer preferably contains less than 15 mol % of 1,2-cyclohexanediyl units.

The highly saturated diene elastomer that is useful for the purposes of the invention may be obtained according to various synthetic methods known to a person skilled in the art, notably as a function of the targeted microstructure of the highly saturated diene elastomer. Generally, it may be prepared by copolymerization at least of a 1,3-diene, preferably 1,3-butadiene, and of ethylene and according to known synthetic methods, in particular in the presence of a catalytic system comprising a metallocene complex. Mention may be made, in this respect, of catalytic systems based on metallocene complexes, which catalytic systems are described in documents EP 1 092 731, WO 2004/035639, WO 2007/054223 and WO 2007/054224, and also WO 2020/070442, WO 2020/070443 and WO 2020/074804 in the name of the applicant.

The highly saturated diene elastomer, including when it is random, can also be prepared by a process using a catalytic system of preformed type, such as those described in documents WO 2017/093654 A1, WO 2018/020122 A1 and WO 2018/020123 A1. The highly saturated diene elastomer is random according to one embodiment of the invention.

The highly saturated diene elastomer that is useful for the purposes of the invention may consist of a mixture of highly saturated diene elastomers which differ from each other in their microstructures or in their macrostructures.

According to the invention, the content of the highly saturated diene elastomer in the rubber composition is preferably at least 50 parts by weight per hundred parts of elastomer of the rubber composition (phr). More preferably, the content of highly saturated diene elastomer in the rubber composition varies in a range extending from 60 to 100 phr, preferentially 80 to 100 phr. More preferentially, it varies in a range extending from 90 to 100 phr.

In addition, the elastomer matrix of the composition of the invention may comprise at least one other elastomer, in a minor amount. Particularly the diene elastomers known to a person skilled in the art for their use in the field of tyres, such as a polybutadiene (abbreviated to “BR”), a synthetic polyisoprene (TR), natural rubber (NR), a butadiene copolymer such as a butadiene-styrene copolymer (SBR), an isoprene copolymer and mixtures of these elastomers.

### 2—Liquid Butadiene Polymer

The composition of the invention comprises a liquid butadiene polymer functionalized along the chain by pendent alkoxysilyl functions having a number-average molar mass (Mn) greater than or equal to 1000 g/mol.

A “liquid butadiene polymer” according to the invention is understood to mean a relatively viscous butadiene polymer which is liquid at ambient temperature (about 23° C. at 1 atm), that is to say, as a reminder, having the ability to eventually assume the shape of its container.

A “butadiene polymer” is understood to mean a butadiene homopolymer or copolymer, in other words, a diene polymer selected from the group consisting of polybutadienes, the various butadiene copolymers, and mixtures of these polymers. Among the butadiene copolymers, mention will be made in particular of copolymers of butadiene and a vinylaromatic monomer, preferably styrene.

Preferably, the liquid butadiene polymer is a liquid polybutadiene.

According to the invention, the liquid butadiene polymer is functionalized along the chain by alkoxysilyl functions. The expression “polymer functionalized along the chain” is understood to mean a polymer comprising several pendent alkoxysilyl functional groups distributed along the main chain of the elastomer.

An “alkoxysilyl function, which is optionally partially or completely hydrolysed” is understood to mean a function corresponding to the formula —Si(OR)ₙR′₃₋ₙ, each R, independently of one another, represents a hydrogen atom or a C₁-C₁₀, preferably C₁-C₄, alkyl radical or a C₆-C₁₀ aryl radical, each R′, independently of the others, denotes a C₁-C₁₀, preferably C₁-C₄, alkyl radical or a C₆-C₁₀ aryl radical and n is an integer from 1 to 3, preferably 3. Preferably, the alkoxysilyl function is a function corresponding to the formula —Si(OR)₃, R being as defined above, preferably a C₁-C₁₀, more preferably C₁-C₄, alkyl. More preferentially still, the alkoxysilyl function is a trimethoxysilyl or triethoxysilyl function, which is optionally partially or completely hydrolysed.

Thus, advantageously, the liquid butadiene polymer functionalized along the chain by alkoxysilyl functions is a functionalized liquid polybutadiene bearing along the chain trialkoxysilyl functions, preferably trimethoxysilyl or triethoxysilyl functions, which are optionally partially or completely hydrolysed.

According to the invention, the liquid butadiene polymer functionalized along the chain has a number-average molar mass (Mn) of greater than or equal to 1000 g/mol and preferentially less than or equal to 50 000 g/mol, more preferentially less than or equal to 30 000 g/mol, more preferentially still less than or equal to 10 000 g/mol. Thus, according to certain embodiments, the liquid butadiene polymer functionalized along the chain has a number-average molar mass (Mn) ranging from 1000 g/mol to 10 000 g/mol.

Preferably, the liquid butadiene polymer according to the invention also has a Tg within a range extending from −60° C. to −100° C., more preferentially from −80° C. to −100° C.

According to the invention, the various preferential characteristics above of the liquid butadiene polymer can be combined with one another.

According to certain embodiments of the invention, the liquid butadiene polymer functionalized along the chain may comprise units (a), (b) and (c) corresponding to the following formulae:

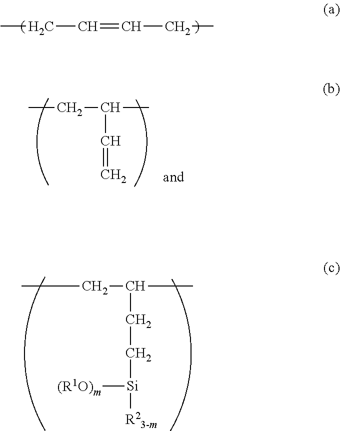

each R¹ representing, independently, a hydrogen atom or a C₁-C₁₀ alkyl radical, preferably a C₁-C₄ alkyl or a C₆-C₁₀ aryl,
each R² representing, independently, a C₁-C₁₀, preferably C₁-C₄, alkyl radical or C₆-C₁₀ aryl radical,
m is an integer and is equal to 1, 2 or 3, preferably 3.

According to certain preferred embodiments of the invention, each R¹ represents a methyl radical or each R¹ represents an ethyl radical.

According to these embodiments of the invention, m is equal to 3 and each R¹ represents a methyl radical or each R¹ represents an ethyl radical. Preferably in that case, m is equal to 3 and each R¹ represents an ethyl radical.

According to certain embodiments of the invention, the liquid butadiene polymer comprises at most 10 mol % of unit (b), preferably from 0 to 5 mol %. According to certain embodiments of the invention, the liquid butadiene polymer does not comprise a unit (b). The microstructure of the liquid polymer is determined by ¹H NMR analysis as described below in the section dedicated to the examples.

According to certain embodiments of the invention, the liquid butadiene polymer essentially consists of units (a) and units (c).

These various embodiments can be combined with one another. Thus, according to certain particular embodiments of the invention, the liquid butadiene polymer essentially consists of units (a) and units (c), in which m is equal to 3 and each R¹ represents a methyl radical or each R¹ represents an ethyl radical, preferably each R¹ represents an ethyl radical.

The liquid butadiene polymer functionalized along the chain by alkoxysilyl functions can be obtained in a simple and known manner by hydrosilylation of the pendent carbon-carbon double bonds of the 1,2-vinyl units of the butadiene part of a liquid butadiene polymer.

Such polymers are for example described in documents EP3466996A1 and EP3293217A1.

The Tg of the liquid polymer is measured by DSC according to the standard ASTM D3418 (1999). The macrostructure (Mw, Mn and PDI) of the liquid polymer is determined by size exclusion chromatography (SEC): solvent tetrahydrofuran; temperature 35° C.; concentration 1 g/l; flow rate 1 ml/min; solution filtered through a filter with a porosity of 0.45 μm before injection; Moore calibration with polystyrene standards; set of 3 Waters columns in series (Styragel HR4E, HR1 and HR0.5); detection by differential refractometer (Waters 2410) and its associated operating software (Waters Empower).

Liquid butadiene polymers which are useful for the purposes of the invention may be found commercially under the names, for example, X-12-1267B, X-12-1267B-ES and X-12-1287A sold by the company Shin-Etsu.

According to any one of the embodiments of the invention, the content of liquid butadiene polymer functionalized along the chain by pendent alkoxysilyl functions is advantageously greater than or equal to 1 phr, preferably in a range of from 1 phr to 30 phr, preferentially from 3 to 20 phr, more preferentially from 5 phr to 15 phr.

The liquid butadiene polymer functionalized along the chain by alkoxysilyl functions may be a mixture of several liquid butadiene polymers functionalized along the chain by alkoxysilyl functions as described above.

### 3—Reinforcing Filler

The composition according to the invention comprises a reinforcing filler. Use may be made of any type of reinforcing filler known for its abilities to reinforce a rubber composition which can be used for the manufacture of tyres, for example an organic filler, such as carbon black, a reinforcing inorganic filler, such as silica or alumina, or also a blend of these two types of filler. More particularly, the reinforcing filler comprises at least a silica, a carbon black or a mixture of silica and carbon black.

All carbon blacks, notably “tyre-grade” blacks, are suitable as carbon blacks. Among the latter, mention will be made more particularly of the reinforcing carbon blacks of the 100, 200 or 300 series (ASTM grades), such as the N115, N134, N234, N326, N330, N339, N347 or N375 blacks, or else, depending on the applications targeted, blacks of higher series (for example N660, N683 or N772). The carbon blacks might, for example, be already incorporated in an isoprene elastomer in the form of a masterbatch (see, for example, applications WO 97/36724 and WO 99/16600).

Mention may be made, as examples of organic fillers other than carbon blacks, of functionalized polyvinyl organic fillers, such as described in applications WO-A-2006/069792, WO-A-2006/069793, WO-A-2008/003434 and WO-A-2008/003435.

The composition can comprise one type of silica or a blend of several silicas. The silica used can be any reinforcing silica known to a person skilled in the art, in particular any precipitated or fumed silica having a BET specific surface area and also a CTAB specific surface area which are both less than 450 m²/g, preferably from 30 to 400 m²/g. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Solvay, the Hi-Sil EZ150G silica from PPG, the Zeopol 8715, 8745 and 8755 silicas from Huber, treated precipitated silicas, such as, for example, the silicas “doped” with aluminium described in application EP-A-0735088, or the silicas with a high specific surface area as described in application WO 03/16837.

According to one embodiment of the invention, the reinforcing filler is predominantly an inorganic reinforcing filler (preferably silica); that is to say it comprises more than 50% (>50%) by weight of an inorganic reinforcing filler, such as silica, relative to the total weight of the reinforcing filler. Optionally according to this variant, the reinforcing filler also comprises carbon black. According to this option, the carbon black is used in a content of less than or equal to 20 phr, more preferentially less than or equal to 10 phr (for example, the carbon black content may be in a range from 0.5 to 20 phr, notably from 1 to 10 phr). Within the ranges indicated, the colouring (black pigmentation agent) and anti-UV properties of carbon blacks are exploited, without otherwise penalizing the typical performance provided by the reinforcing inorganic filler.

In the present account, the BET specific surface area is determined by gas adsorption using the Brunauer-Emmett-Teller method described in “The Journal of the American Chemical Society”, vol. 60, page 309, February 1938), and more specifically according to a method derived from the standard NF ISO 5794-1, Annex E, of June 2010 [multipoint (5 point) volumetric method—gas: nitrogen—degassing under vacuum: one hour at 160° C.—relative pressure p/po range: 0.05 to 0.2].

For the inorganic fillers, such as silica, for example, the CTAB specific surface values were determined according to the standard NF ISO 5794-1, Annex G, of June 2010. The process is based on the adsorption of CTAB (N-hexadecyl-N,N,N-trimethylammonium bromide) on the “outer” surface of the reinforcing filler.

A person skilled in the art will understand that, as filler equivalent to silica, use might be made of a reinforcing filler of another nature, in particular organic nature, provided that this reinforcing filler is covered with a layer of silica or else comprises functional sites, in particular hydroxyl sites, at its surface which require the use of a coupling agent in order to establish the bond between the filler and the elastomer.

The physical state in which the reinforcing filler is provided is not important, whether in the form of a powder, of micropearls, of granules, of beads or any other appropriate densified form.

For the purposes of the invention, the content of total reinforcing filler (carbon black and/or reinforcing inorganic filler, such as silica) is from 5 to 150 phr, more preferably from 20 to 60 phr. Below 5 phr of filler, the composition might not be sufficiently reinforced, whereas, above 150 phr of filler, the composition might be less effective in terms of rolling resistance.

Silica is preferably used as the predominant filler. Silica preferentially represents more than 50% by weight of the reinforcing filler. In other words, the proportion of silica in the reinforcing filler is greater than 50% by weight of the total weight of the reinforcing filler. More preferentially, the silica represents more than 85% by weight of the reinforcing filler. According to certain preferred embodiments, the silica content varies from 20 phr to 60 phr.

The carbon black, when it is present, is then used in a minor amount, preferably at a content within a range extending from 0.1 to 10 phr, more preferentially from 0.5 to 10 phr, in particular from 1 to 5 phr.

In order to couple the reinforcing inorganic filler to the diene elastomer, use may be made, in a well-known manner, of an at least bifunctional coupling agent (or bonding agent) intended to provide a satisfactory connection, of chemical and/or physical nature, between the inorganic filler (surface of its particles) and the diene elastomer. Use is made in particular of organosilanes or polyorganosiloxanes which are at least bifunctional. The term “bifunctional” refers to a compound having a first functional group that is capable of interacting with the inorganic filler and a second functional group that is capable of interacting with the diene elastomer. For example, such a bifunctional compound can comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, the organosilanes are selected from the group consisting of (symmetrical or asymmetrical) organosilane polysulfides, such as bis(3-triethoxysilylpropyl) tetrasulfide, abbreviated to TESPT, sold under the name Si69 by Evonik, or bis(triethoxysilylpropyl) disulfide, abbreviated to TESPD, sold under the name Si75 by Evonik, polyorganosiloxanes, mercaptosilanes and blocked mercaptosilanes, such as NXT-Silane or NXT-Z45 Silane, sold by Momentive. Of course, use might also be made of mixtures of these coupling agents.

A person skilled in the art will understand that the content of coupling agent depends on the amount of reinforcing inorganic filler to be coupled to the elastomer. Typically, the content of coupling agent represents from 0.5% to 15% by weight, relative to the amount of reinforcing inorganic filler, in particular silica.

The composition according to the invention may optionally also contain coupling activators, agents for covering the inorganic fillers or more generally processing aids capable, in a known manner, by virtue of an improvement in the dispersion of the filler in the rubber matrix and of a lowering of the viscosity of the composition, of improving its ability to be processed in the uncured state, these agents being known moreover.

### 4—Crosslinking System

The crosslinking system can be any type of system known to a person skilled in the art in the field of rubber compositions for tyres. It may notably be based on sulfur and/or on peroxide and/or on bismaleimides.

Preferentially, the crosslinking system is based on sulfur; it is then referred to as a vulcanization system. The sulfur can be contributed in any form, in particular in the form of molecular sulfur or of a sulfur-donating agent. At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or else known vulcanization retarders.

The sulfur is used in a preferential content of between 0.2 phr and 10 phr, more preferentially between 0.3 and 5 phr. The vulcanization accelerator or mixture of vulcanization accelerators is used in a preferential content of between 0.5 and 10 phr, more preferentially between 0.5 and 5 phr.

Use may be made, as accelerator, of any compound that is capable of acting as an accelerator for the vulcanization of diene elastomers in the presence of sulfur, notably accelerators of the thiazole type, and also derivatives thereof, or accelerators of sulfenamide, thiuram, dithiocarbamate, dithiophosphate, thiourea and xanthate type. As examples of such accelerators, mention may notably be made of the following compounds: 2-mercaptobenzothiazyl disulfide (abbreviated to MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC) and mixtures of these compounds.

### 5—Possible Additives

The rubber compositions according to the invention may optionally also include all or some of the usual additives customarily used in elastomer compositions for tyres: pigments, plasticizers, protective agents such as anti-ozone waxes, chemical anti-ozonants, antioxidants, anti-fatigue agents, reinforcing resins (as described, for example, in application WO 02/10269).

It goes without saying that the invention relates to the rubber compositions described previously both in the “uncured” or non-crosslinked state (i.e., before curing) and in the “cured” or crosslinked, or else vulcanized, state (i.e., after crosslinking or vulcanization).

### 6—Preparation of the Rubber Composition

The composition in accordance with the invention can be manufactured in appropriate mixers using two successive preparation phases well known to a person skilled in the art:
a first phase of thermomechanical working or kneading (known as the “non-productive” phase), that can be performed in a single thermomechanical step during which all the necessary constituents, notably the elastomer matrix, the polybutadiene liquid polymer, the reinforcing filler and the various other optional additives, with the exception of the crosslinking system, are introduced into an appropriate mixer, such as a standard internal mixer (for example of “Banbury” type). The incorporation of the optional filler in the elastomer can be carried out in one or more goes while kneading thermomechanically. In the case where the filler is already incorporated, totally or partly, in the elastomer in the form of a masterbatch, as is described, for example, in patent application WO 97/36724 or WO 99/16600, it is the masterbatch which is directly kneaded and, if appropriate, the other elastomers or fillers present in the composition which are not in the masterbatch form, and also the various other optional additives other than the crosslinking system, are incorporated.
a second phase of mechanical working (“productive” phase), which is carried out in an external mixer, such as an open mill, after cooling the mixture obtained during the non-productive first phase down to a lower temperature, typically below 120° C.

Such phases are well known to a person skilled in the art.

The final composition thus obtained is then calendered, for example in the form of a film or of a sheet, notably for laboratory characterization, or else is extruded (or co-extruded with another rubber composition) in the form of a rubber semi-finished product (or profiled element) that may be used in a tyre, for example as a tread. These products can subsequently be used for the manufacture of tyres, according to the techniques known to a person skilled in the art.

The composition may be either in the uncured state (before crosslinking or vulcanization) or in the cured state (after crosslinking or vulcanization), or may be a semi-finished product which can be used in a tyre.

The crosslinking (or curing), if appropriate the vulcanization, is carried out in a known way at a temperature generally of between 130° C. and 200° C., for a sufficient time which can vary, for example, between 5 and 90 min as a function in particular of the curing temperature, of the crosslinking system adopted and of the kinetics of crosslinking of the composition under consideration.

### 7—Tyre

Another subject of the present invention is a pneumatic or non-pneumatic tyre comprising a rubber composition according to the invention.

The abovementioned features of the present invention, and also others, will be better understood on reading the following description of several exemplary embodiments of the invention, which are given by way of nonlimiting illustration.

### EXEMPLARY EMBODIMENTS OF THE INVENTION

### 1—Tests and Measurements

### II.1-1) Determination of the Microstructure of the Polymers:

The microstructure of the polymers is determined by ¹H NMR analysis, replaced by ¹³C NMR analysis when the resolution of the ¹H NMR spectra does not enable the assignment and the quantification of all the species. The measurements are performed using a Bruker 500 MHz NMR spectrometer at frequencies of 500.43 MHz for proton observation and 125.83 MHz for carbon observation.

For the polymers that are insoluble but have the ability to swell in a solvent, a 4 mm z-grad HRMAS probe is used for proton and carbon observation in proton-decoupled mode. The spectra are acquired at spin speeds of 4000 Hz to 5000 Hz.

For the measurements on soluble polymers, a liquid NMR probe is used for proton and carbon observation in proton-decoupled mode.

The insoluble samples are prepared in rotors filled with the material analysed and a deuterated solvent which makes swelling possible, in general deuterated chloroform (CDCl₃). The solvent used must always be deuterated and its chemical nature may be adapted by a person skilled in the art. The amounts of material used are adjusted so as to obtain spectra with a sufficient sensitivity and resolution.

The soluble samples are dissolved in a deuterated solvent (approximately 25 mg of polymer in 1 ml), in general deuterated chloroform (CDCl₃). The solvent or solvent blend used must always be deuterated and its chemical nature may be adapted by a person skilled in the art.

In both cases (soluble sample or swollen sample):
for proton NMR, a 300 single pulse sequence is used. The spectral window is adjusted to observe all the resonance lines belonging to the molecules analysed. The accumulation number is adjusted in order to obtain a signal to noise ratio which is sufficient for the quantification of each unit. The recycle delay between each pulse is adapted to obtain a quantitative measurement.

For the carbon NMR, a 30° single pulse sequence is used with proton decoupling only during acquisition to avoid the nuclear Overhauser effects (NOE) and to remain quantitative. The spectral window is adjusted to observe all the resonance lines belonging to the molecules analysed. The accumulation number is adjusted in order to obtain a signal to noise ratio which is sufficient for the quantification of each unit. The recycle delay between each pulse is adapted in order to obtain a quantitative measurement.

The NMR measurements are carried out at 25° C.

### II.1-2 Measurement of the Dynamic Properties:

The dynamic properties G* (25%) and tan δₘₐₓ (25%) at 60° C. are measured on a viscosity analyser (Metravib VA4000) according to the standard ASTM D 5992-96. The response of a sample of crosslinked composition (cylindrical test specimen with a thickness of 4 mm and a cross section of 400 mm²), subjected to a simple alternating sinusoidal shear stress, at a frequency of 10 Hz, under defined temperature conditions, for example at 60° C., according to the standard ASTM D 1349-99, is recorded. A strain amplitude sweep is performed from 0.1% to 100% (outward cycle) and then from 100% to 1% (return cycle). The results exploited are the complex dynamic shear modulus G* and the loss factor tan(6). The value of tan(6) at 25% strain observed at 60° C., denoted tan δₘₐₓ (25%), and the complex dynamic shear modulus G* at 25% strain, at 60° C., are shown for the return cycle.

The tan δₘₐₓ (25%) measurement is a descriptor of the hysteresis and therefore an indication of the rolling resistance property of the tyre. The value in base 100 is calculated according to the operation: (tan δₘₐₓ (25%) value at 60° C. of the control/tan δₘₐₓ (25%) value at 60° C. of the sample)*100. In this way, a lower value represents a reduction in the hysteresis performance (i.e. an increase in the hysteresis), while a higher value represents a better hysteresis performance (i.e. a lower hysteresis).

The G* (25%) measurement is a descriptor of the stiffness and therefore an indication of the wear resistance property of the tyre. The value in base 100 is calculated according to the operation: (G* (25%) value at 60° C. of the sample/G* (25%) value at 60° C. of the control)*100. In this way, a lower value represents a decrease in the stiffness, whereas a higher value represents a better stiffness.

### 2—Preparation of the Rubber Compositions

The rubber compositions, the details of the formulation of which are given in Table 1, were prepared in the following manner:

The elastomer is introduced into an internal mixer (final degree of filling: approximately 70% by volume), the initial vessel temperature of which is approximately 90° C. When the temperature reaches 100° C., the butadiene liquid polymer, the silica, the carbon black and the coupling agent, and also the various other ingredients, with the exception of the sulfur and vulcanization accelerators, are introduced. Thermomechanical working (non-productive phase) is then performed in one step, which lasts in total approximately 3 to 4 min, until a maximum “dropping” temperature of 160° C. is reached. The mixture thus obtained is recovered and cooled, and sulfur and the vulcanization accelerators are then incorporated on an open mill at 25° C., everything being mixed (productive phase) for an appropriate time (for example 5 minutes).

The compositions thus obtained are subsequently calendered, either in the form of sheets (thickness of 2 to 3 mm) or of thin films of rubber, for the measurement of their physical or mechanical properties. The crosslinking was then carried out at a temperature of 150° C., under pressure.

### Preparation of the Elastomer

Elastomer E1 is a highly saturated diene elastomer, copolymer of ethylene and 1,3-butadiene, prepared according to the following procedure:
butyloctylmagnesium (BOMAG) in solution in methylcyclohexane and the catalytic system are added to a 70 l reactor containing methylcyclohexane (64 l), ethylene (5600 g) and 1,3-butadiene (2948 g). The Mg/Nd ratio is 6.2. The volume of the catalyst system solution introduced is 840 ml, the concentration of Nd in the catalyst system solution being 0.0065 M. The reaction temperature is regulated at a temperature of 80° C. and the polymerization reaction starts. The polymerization reaction takes place at a constant pressure of 8.3 bar. The reactor is fed throughout the polymerization with ethylene and 1,3-butadiene in the molar proportions 73/27. The polymerization reaction is stopped by cooling, degassing of the reactor and addition of ethanol. An antioxidant is added to the polymer solution. The copolymer is recovered after steam stripping and drying to constant mass. The polymerization time is 225 minutes. The weighed mass (6.206 kg) makes it possible to determine the mean catalytic activity of the catalyst system, expressed in kilograms of polymer synthesized per mole of neodymium metal and per hour (kg/mol·h). The copolymer has an ML value equal to 62.

The catalyst system is a preformed catalyst system. It is prepared in methylcyclohexane from a metallocene, [Me₂Si(Flu)₂Nd(μ-BH₄)₂Li(THF)] at 0.0065 mol/l, a cocatalyst, butyloctylmagnesium (BOMAG), the BOMAG/Nd molar ratio of which is equal to 2.2, and a preformation monomer, 1,3-butadiene, the 1,3-butadiene/Nd molar ratio of which is equal to 90. The medium is heated at 80° C. over a period of 5 h. It is prepared according to a method of preparation in accordance with section 11.1 of patent application WO 2017/093654 A1.

TABLE 1

| | T1 | C1 | C2 | C3 | C4 | C5 | C6 | C7 |
|---|---|---|---|---|---|---|---|---|
| Elastomer El (1) | 100 | 100 | 100 | 100 | 100 | 100 | 100 | 100 |
| Silica (2) | 38 | 38 | 38 | 38 | 38 | 38 | 31 | 31 |
| Carbon black (3) | 2 | 2 | 2 | 2 | 2 | 2 | 2 | 2 |
| Coupling agent (4) | 3.1 | 3.1 | 3.1 | 3.1 | 3.1 | 3.1 | 2.5 | 2.5 |
| LBR-307 (5) | | 10 | | | | | | |
| LBR-352 (6) | | | 10 | | | | | |
| LBR-361 (7) | | | | 10 | | | | |
| X-12-1267B-ES (8) | | | | | 5 | 10 | | 5 |
| DPG (9) | 1.2 | 1.2 | 1.2 | 1.2 | 1.2 | 1.2 | 1 | 1 |
| Ozone wax (10) | 1 | 1 | 1 | 1 | 1 | 1 | 1 | 1 |
| Antioxidant 6PPD (11) | 2 | 2 | 2 | 2 | 2 | 2 | 2 | 2 |
| Stearic acid (12) | 2 | 2 | 2 | 2 | 2 | 2 | 2 | 2 |
| ZnO (13) | 2.5 | 2.5 | 2.5 | 2.5 | 2.5 | 2.5 | 2.5 | 2.5 |
| Sulfur | 1.3 | 1.3 | 1.3 | 1.3 | 1.3 | 1.3 | 1.3 | 1.3 |
| CBS (14) | 1 | 1 | 1 | 1 | 1 | 1 | 1 | 1 |
| G*25% at 60° C. | 100 | 83 | 76 | 71 | 132 | 136 | 76 | 102 |
| (base 100) | | | | | | | | |
| tanδₘₐₓ 25% at 60° C. | 100 | 79 | 84 | 82 | 109 | 115 | 108 | 121 |
| (base 100) | | | | | | | | |

(1) Copolymer of ethylene and of 1,3-butadiene containing 74 mol % ethylene units, 19 mol % butadiene units in the form of 1,2 and 1,4 units and 7 mol % 1,2-cyclohexanediyl units, with a Tg of −44° C.
(2) Zeosil 1165 MP, from Solvay-Rhodia, in the form of micropearls
(3) Carbon black of N234 grade according to the standard ASTM D-1765, from Cabot
(4) Silane Mercapto - Thiocarboxylate Oligomer (NXT-Z45) - CAS 922519-17-3 - Momentive
(5) LBR-307, Kuraray, non-functional liquid BR with a Tg of −95° C. and an Mn of 8000 g/mol
(6) LBR-352, Kuraray, non-functional liquid BR with a Tg of −60° C. and an Mn of 9000 g/mol
(7) LBR-361, Kuraray, non-functional liquid BR with a Tg of −49° C. and an Mn of 5500 g/mol
(8) X-12-1267B-ES, Shin-Etsu, liquid BR functional along the chain with a Tg of −90° C. and an Mn of 4700 g/mol, of formula 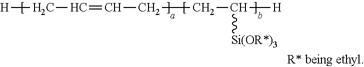
(9) Perkacit DPG diphenylguanidine from Flexsys
(10) Anti-ozone wax, Varazon 4959 from Sasol Wax
(11) N-(1,3-Dimethylbutyl)-N′-phenyl-p-phenylenediamine, Santoflex 6PPD from Flexsys
(12) Stearic acid, Pristerene 4931 from Uniqema
(13) Zinc oxide, industrial grade from Umicore
(14) N-Cyclohexyl-2-benzothiazolesulfenamide, Santocure CBS from Flexsys

### 3—Results

Composition T1 is the control without a liquid butadiene polymer in order to evaluate the effect of the nature of the liquid butadiene polymer used in compositions C1 to C5. Compositions C4 and C5 are in accordance with the invention.

The results show that the compositions in accordance with the invention, with an elastomer matrix based on an EBR and a liquid polybutadiene functionalized along the chain by alkoxysilyl functions, makes it possible to significantly improve the hysteresis performance (rolling resistance) and the stiffness compared to compositions comprising another functionalized or non-functionalized liquid polybutadiene.

This effect is observed, quite unexpectedly, with a lower content of liquid polybutadiene functionalized along the chain by alkoxysilyl functions (C4).

The results also show, quite unexpectedly, that when the volume fraction of filler is reduced, the stiffness is maintained while improving the hysteresis performance (comparative T1 and C7 (according to the invention) in view of C6). Thus, the combined use of a highly saturated diene elastomer and a liquid butadiene polymer functionalized along the chain by pendent alkoxysilyl functions makes it possible to reduce the volume fraction of filler in the composition while maintaining the desired stiffness.

1.-15. (canceled)

16. A rubber composition based on at least:
an elastomer matrix predominantly comprising a highly saturated diene elastomer, which highly saturated diene elastomer is a copolymer of ethylene and a 1,3-diene in which ethylene units represent at least 50 mol % of monomer units of the copolymer;
a reinforcing filler;
a vulcanization system; and
a liquid butadiene polymer functionalized along a chain by pendent alkoxysilyl functions, which are optionally completely or partially hydrolyzed, having a number-average molar mass Mn greater than or equal to 1000 g/mol.

17. The rubber composition according to claim 16, wherein the ethylene units represent at least 50 mol % and at most 95 mol % of the monomer units of the copolymer.

18. The rubber composition according to claim 16, wherein the copolymer of ethylene and a 1,3-diene is a copolymer of ethylene and 1,3-butadiene.

19. The rubber composition according to claim 16, wherein a content of highly saturated diene elastomer varies within a range extending from 60 to 100 phr.

20. The rubber composition according to claim 16, wherein the liquid butadiene polymer is a polybutadiene.

21. The rubber composition according to claim 16, wherein a content of liquid butadiene polymer is within a range of from 1 to 30 phr.

22. The rubber composition according to claim 16, wherein the liquid butadiene polymer has a Tg within a range extending from −60° C. to −100° C.

23. The rubber composition according to claim 16, wherein the liquid butadiene polymer has a number-average molar mass of greater than or equal to 1000 g/mol and less than or equal to 50 000 g/mol.

24. The rubber composition according to claim 16, wherein the liquid butadiene polymer comprises units: 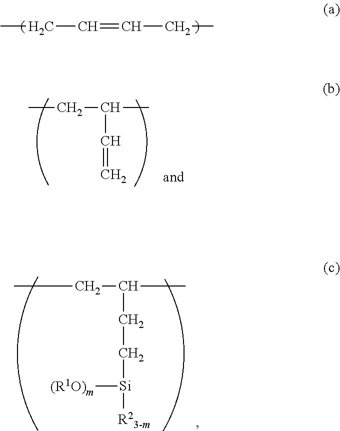
each R¹ representing, independently, a hydrogen atom or a C₁-C₁₀ alkyl radical or C₆-C₁₀ aryl radical,
each R² representing, independently, a C₁-C₁₀ alkyl radical or C₆-C₁₀ aryl radical, and
m is an integer and is equal to 1, 2 or 3.

25. The rubber composition according to claim 24, wherein the liquid butadiene polymer does not comprise a 1,2-vinyl unit (b).

26. The rubber composition according to claim 16, wherein the pendent alkoxysilyl functions, which are optionally completely or partially hydrolyzed, of the liquid butadiene polymer functionalized along the chain, are trimethoxysilyl or triethoxysilyl functions.

27. The rubber composition according to claim 16, wherein a content of reinforcing filler ranges from 5 to 150 phr.

28. The rubber composition according to claim 16, wherein the reinforcing filler comprises a silica as a predominant reinforcing filler.

29. The rubber composition according to claim 16, wherein a content of silica is within a range extending from 20 to 60 phr.

30. A pneumatic or non-pneumatic tire comprising the rubber composition according to claim 16.
